(19) United States
(12) Patent Application Publication
(10) Pub. No.: US 2017/0173461 A1
(43) Pub. Date: Jun. 22, 2017

(54) VIDEO GAME COMMUNICATIONS PLATFORM

(71) Applicant: MiniGamr, LLc, North Salt Lake, UT (US)

(72) Inventors: Jared A. Pack, North Salt Lake, UT (US); Francisco Javier Barrera Gomez, Lleida (ES); Raul Buisan Esporrin, Lleida (ES); Javier Baixauli Herraez, Lleida (ES)

(73) Assignee: MiniGamr LLC, North Salt Lake, UT (US)

(21) Appl. No.: 14/977,619

(22) Filed: Dec. 21, 2015

(51) Int. Cl. A63F 13/35

(52) U.S. Cl. CPC A63F 13/35

(57) ABSTRACT

Apparatuses, systems, methods, and computer program products are disclosed for video game communications. A message module is configured to receive a message from a first user to a second user specified by the first user and to send a link to a portion of a video game associated with the message to the second user. A trigger module is configured to determine that a second user has satisfied a trigger within a portion of a video game. A display module is configured to present a message to a second user in response to a trigger module determining that a second user has satisfied a trigger.

### FIELD

This invention relates to video games and more particularly relates to video game communications.

### BACKGROUND

Video game developers are always looking for new ways to encourage people to play the video games they develop, hoping their games will go viral. However, simply advertising a video game can be expensive, with no guarantee that the advertisements will be effective.

### SUMMARY

Apparatuses for video game communications is disclosed. In one embodiment, a message module is configured to receive a message from a first user to a second user specified by the first user. A message module, in certain embodiments, is configured to send a link to a portion of a video game associated with a message to a second user. In a further embodiment, a trigger module is configured to determine that a second user has satisfied a trigger within a portion of a video game. A display module, in certain embodiments, is configured to present a message to a second user in response to the second user satisfying a trigger.

Methods for video game communications are also disclosed. In one embodiment, a method includes receiving, at a hardware device of a second user, a link to a portion of a video game associated with a message from a first user to the second user, with the video game executing on the hardware device of the second user. In certain embodiments, a method includes determining that a second user has satisfied a trigger within a portion of a video game on a hardware device of the second user. A method, in one embodiment, includes displaying a message to a second user on an electronic display of a hardware device of the second user in response to determining that the second user has satisfied a trigger.

Computer program products comprising computer readable storage media storing computer executable program code to perform operations for video game communications are disclosed. In one embodiment, an operation includes receiving, at a hardware device of a second user, a link to a portion of a video game associated with a message from a first user to the second user, with the video game executing on the hardware device of the second user. An operation, in a further embodiment, includes determining that a second user has satisfied a trigger within a portion of a video game on a hardware device. In certain embodiments, an operation includes presenting a message to a second user on a hardware device in response to determining that a second user has satisfied a trigger.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for video game communications;

FIG. 2A is a schematic block diagram illustrating one embodiment of a video game communications module;

FIG. 2B is a schematic block diagram illustrating a further embodiment of a graphical display for video game communications;

FIG. 3 is a schematic block diagram illustrating one embodiment of a graphical display for video game communications;

FIG. 4 is a schematic block diagram illustrating a further embodiment of a graphical display for video game communications;

FIG. 5 is a schematic block diagram illustrating a further embodiment of a graphical display for video game communications;

FIG. 6A is a schematic block diagram illustrating a further embodiment of a graphical display for video game communications;

FIG. 6B is a schematic block diagram illustrating a further embodiment of a graphical display for video game communications;

FIG. 6C is a schematic block diagram illustrating a further embodiment of a graphical display for video game communications;

FIG. 7 is a schematic flow chart diagram illustrating one embodiment of a method for video game communications;

FIG. 8 is a schematic flow chart diagram illustrating a further embodiment of a method for video game communications; and

FIG. 9 is a schematic flow chart diagram illustrating a further embodiment of a method for video game communications.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible and/or non-transitory device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

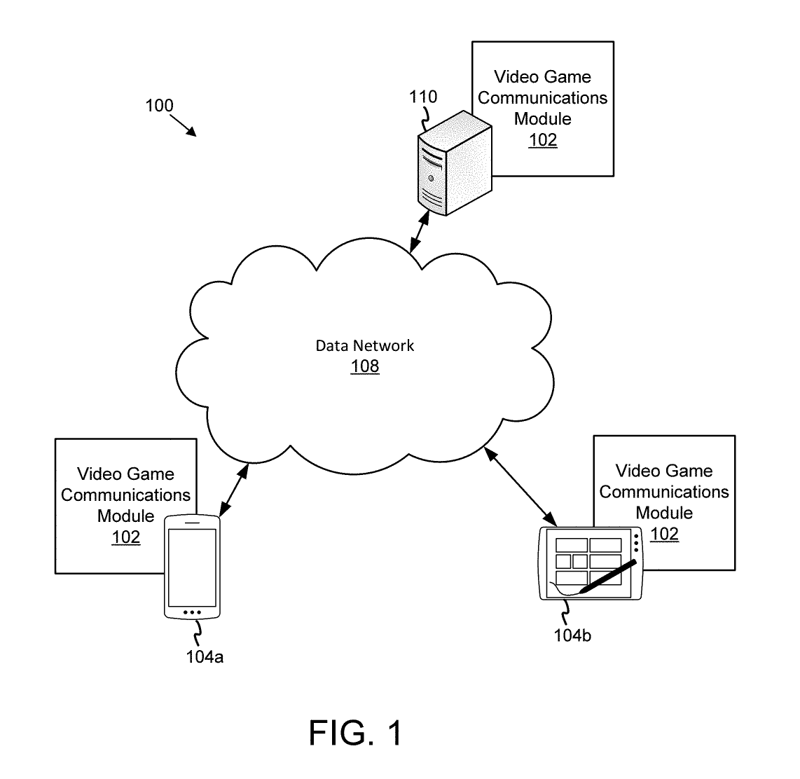

FIG. 1 depicts one embodiment of a system 100 for video game communications. The system 100 may include one or more video game communications modules 102. One or more hardware devices, such as a first user's device 104a, a second user's device 104b, and/or a server 110 may include a video game communications module 102 or a portion thereof. A video game communications module 102 may be in communication with one or more other video game communications module 102 and/or the server 110 (e.g., a server for a video game publisher and/or provider) over a data network 108.

As used herein, the terms “first user” and “second user” are used to denote different users. However, the use of the users is not confined by these designations. For example, in one example, one user may be the “first user” and another user may be the “second user,” and in another example, the user that was the “first user” in a previous example may be the “second user” and the user that was the “second user” in a previous example may be the “first user.” Furthermore, the terms “first user” and “second user” do not necessarily indicate order, rank, sequence, or the like.

The first user's device 104a and the second user's device 104b may include one or more types of hardware devices, comprising one or more processors configured to execute computer executable program code of the video game communications module 102, a non-transitory computer readable storage medium (e.g. volatile and/or non-volatile) for storing computer executable program code of the video game communications module 102, a wireless and/or wired network adapter for communicating data on the data network 108, an electronic display, one or more user input devices (e.g., a touchscreen, a keyboard, a mouse, a touchpad, a joystick or directional pad, one or more buttons, or the like), and/or other hardware computing components. For example, in one embodiment, a user's device 104 may comprise a telephone, such as a cellular phone, mobile phone, smart phone, or the like. In a further embodiment, a user's device 104 may comprise a tablet computer, or the like. In one embodiment, a user's device 104 may comprise a desktop computer, a laptop computer, or another type of computer. In certain embodiments, a user's device 104 may comprise a dedicated gaming device, such as a portable and/or handheld gaming device, a gaming console or set-top box (e.g., with one or more display outputs for connecting to a television, monitor, and/or another electronic display), or the like.

A user's device 104 may store, stream, and/or execute a video game (e.g., a downloadable video game, an internet or network game, a video game cartridge or disk, or the like). In some embodiments, the video game may include a puzzle game, a racing game, a side-scrolling game, a tap to jump game, a first person shooter game, a role playing game, a tower defense game, an action adventure game, a word game, or another type of game. In one embodiment, the video game may include one or more portions. In certain embodiments, a portion of the video game may include one or more discrete portions. For example, a portion may include a level, stage, screen, world, challenge, a portion of one of the foregoing, or the like, of the video game. In one embodiment, a user may access or play the one or more discrete portions sequentially (e.g., level 1, level 2, and so on). In a further embodiment, a user may access or play the one or more discrete portions in a different, non-sequential order (e.g., a user may select a level, a level may be randomly presented, or the like). In one embodiment, a user may access the one or more discrete portions sequentially and may also selectively play or access a portion previously played or accessed (e.g., a completed level or other portion). In certain embodiments, a portion of the video game may include one or more sections or areas.

In one embodiment, the first user may use a first device 104a and/or video game communications module 102 and the second user may use a different device 104b and/or instance of a video game communications module 102. In some embodiments, the first user and the second user may use the same device 104 and/or video game communications module 102 (e.g., using the same device 104 at different times, with a first user leaving a message for the second user, or the like). In a further embodiment, the video game communications module 102 may be configured to distinguish between different users. In one embodiment, the video game being configured to distinguish between different users may include each user using a different account. In one embodiment, the video game being configured to distinguish between different users may include each user using different credentials to login and play the video game. In one embodiment, the account may include an account of a third-party service, such as a third-party service of the server 110, a third-party service in communication with the server 110, or the like.

In some embodiments, the system 100 may include a data network 108. The data network 108, in one embodiment, may include a digital communication network that transmits digital communications related to system 100. The data network 108 may include a wireless network, such as a wireless cellular network, a local wireless network, such as a Wi-Fi network, a Bluetooth® network, or the like. The data network 108 may include a wide area network (“WAN”), a storage area network (“SAN”), a local area network (“LAN”), an optical fiber network, the internet, or other digital communication network. The data network 108 may include two or more networks. The data network 108 may include one or more servers, routers, switches, and/or other networking equipment. The data network 108 may also include computer readable storage media, such as a hard disk drive, an optical drive, non-volatile memory, random access memory (“RAM”), or the like.

In some embodiments, the server 110 may include a desktop computer, a cloud server, a main frame computer, or the like. In certain embodiments, the server 110 may include at least a portion of one or more modules of the video game communications module 102 described below. In one embodiment, the video game communications module 102 may be communicatively coupled to the server 110 through the data network 108. In one embodiment, the server 110 may store data used by the video game communications module 102. In one embodiment, the server 110 may include a third-party service, such as Facebook, Google+, Steam, or the like. In one embodiment, the server may host the third-party service. In a further embodiment, the server 110 may communicate with a third-party service hosted on a different server via the data network 108. In one embodiment, the third-party service may store data used by the video game communications module 102. As described below, the third-party service may facilitate communication between the one or more video game communications modules 102.

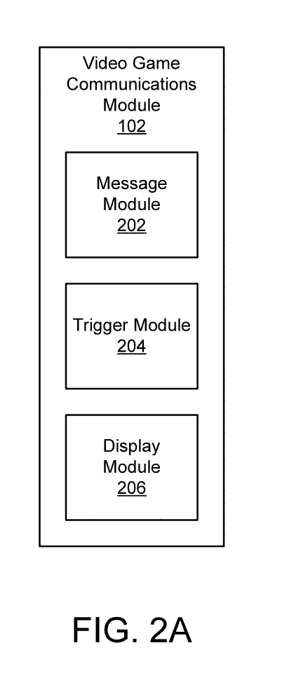

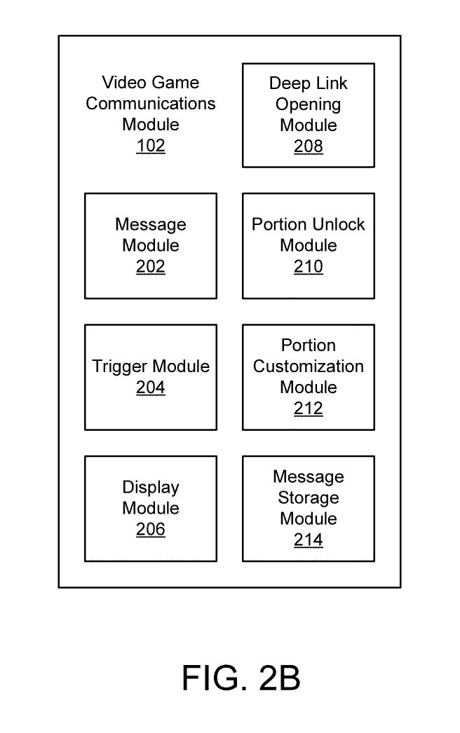

FIG. 2A depicts one embodiment of a video game communications module 102. In one embodiment, the video game communications module 102 may include a message module 202. In one embodiment, the video game communications module 102 may include a trigger module 204. In one embodiment, the video game communications module 102 may include a display module 206.

In one embodiment, the video game communications module 102 may include a message module 202. The message module 202 may be configured to receive a message from a first user (e.g., a directly input message, an uploaded message, a recorded message, a link to a message on a server, a streaming message, or the like). The first user may specify a second user to receive the message. The message module 202 may be configured to send a link to a portion of a video game associated with the message to the second user.

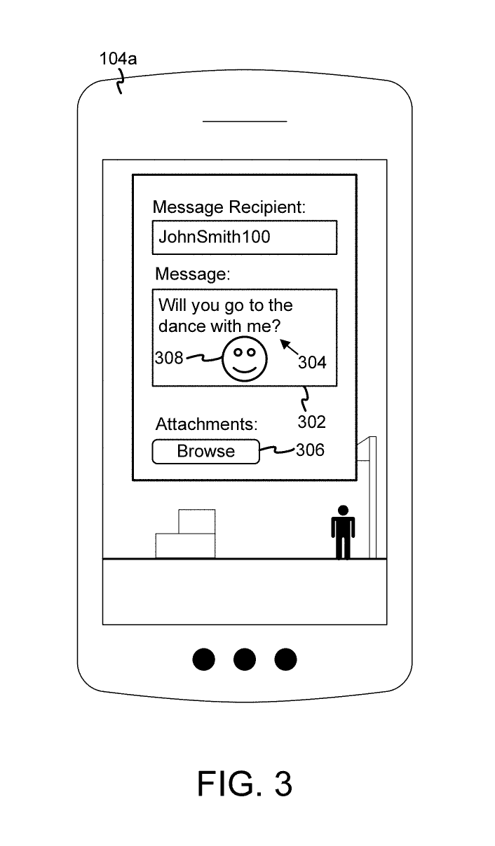

FIG. 3 depicts one embodiment of a graphical display for video game communications. The message module 202 may receive the message 302 from the first user in a variety of ways. For example, in one embodiment, the message 302 may include text 304. The first user may be prompted to enter the text 304 into the message 302. In one embodiment, the first user may type the text 304 into the message 302 using a keyboard such as a physical keyboard, an on-screen keyboard, an external keyboard, voice dictation, or the like. In one embodiment, the message 302 may include audio. The first user may attach audio to the message 302, provide a link to audio hosted on a server (e.g., the server 110, a server of a third party service provider, or the like), record audio, select a pre-recorded audio message, or the like. For example, in one embodiment, the video game communications module 102 may include a recording function and the first user may record the audio using a microphone of the hardware device 104a. In one embodiment, the first user may browse 306 a file system of the video game communications module 102 and attach an audio file to the message 302. In one embodiment, the first user may use the video game communications module 102 to browse 306 the Internet and attach an audio file found on the Internet (e.g., from a URL or link) to the message 302.

In one embodiment, the message may include an image 308. The first user may attach the image 308 to the message 302, provide a link to an image hosted on a server (e.g., the server 110, a server of a third party service provider, or the like), take a photograph, draw an image, select a predefined image from an image library, or the like. For example, in one embodiment, the video game communications module 102 may include a picture-taking function and the first user may take a picture to create the image 308 to attach to the message 302. In one embodiment, the first user may browse 306 a file system of the video game communications module 102 and attach an image file to the message. In one embodiment, the first user may use the video game communications module 102 to browse 306 the Internet and attach an image file found on the Internet (e.g., from a URL or link) to the message 302.

In one embodiment, the message 302 may include a video. The first user may attach the video to the message 302, provide a link to a video hosted on a server (e.g., the server 110, a server of a third party service provider, or the like), record a video, select a pre-recorded video message and/or animation, or the like. For example, in one embodiment, the video game communications module 102 may include a video-recording function and the first user may record a video to create the video to attach the message 302. In one embodiment, the first user may browse 306 a file system of the video game communications module 102 and attach a video file to the message 302. In one embodiment, the first user may use the video game communications module 102 to browse 306 the Internet and attach a video file found on the Internet (e.g., from a URL or link) to the message 302.

In one embodiment, the first user may specify, to the message module 202, a second user to receive the message. For example, in one embodiment, the first user may select the second user from a contact list (e.g., a contact list maintained by and/or otherwise accessible to the message module 202 within the video game). The contact list may be a contact list of the video game communications module 102, a third-party service, an email service, or the like. In one embodiment, the first user may input contact information of the second user, such as a phone number, email address, username of a third-party service, username of the video game, or the like.

In one embodiment, the message module 202 may receive or otherwise determine an identifier for a portion of a video game (e.g., a level) to associate with a message. For example, the message module 202 may associate a portion of a video game that a first user is currently playing and/or has just completed, with a message from the first user to a second user. In a further embodiment, the message module 202 may provide a selector tool to a first user, allowing the first user to select a level or other portion of a video game to associate with a message. The message module 202, in certain embodiments, may include an identifier for a selected portion of a video game associated with a message with and/or in a message itself, for a trigger module 204 associated with a second user (e.g., a destination for the message) to use as a trigger for displaying the message (e.g., in response to the second user completing the selected portion of the video game), as described in greater detail below with regard to the trigger module 204.

The message module 202, in one embodiment, may enforce one or more restrictions and/or rules on portions of a video game which a user may associate with a message. For example, the message module 202 may require that a user first pass and/or complete a level or other portion of a video game before allowing the user to associate it with a message. In a further embodiment, as described below, the message module 202 may allow a user to associate a level or other portion of a video game on which the user needs assistance, even if the user has not yet completed the level or other portion (e.g., the level or other portion may be unlocked or marked as complete for the user in response to a second user completing it to assist the user, or the like). In one embodiment, as described in greater detail below, the message module 202 may allow a user to design and/or create a custom level or other portion of a video game to associate with a message, to select a custom level created by another user to associate with a message, or the like.

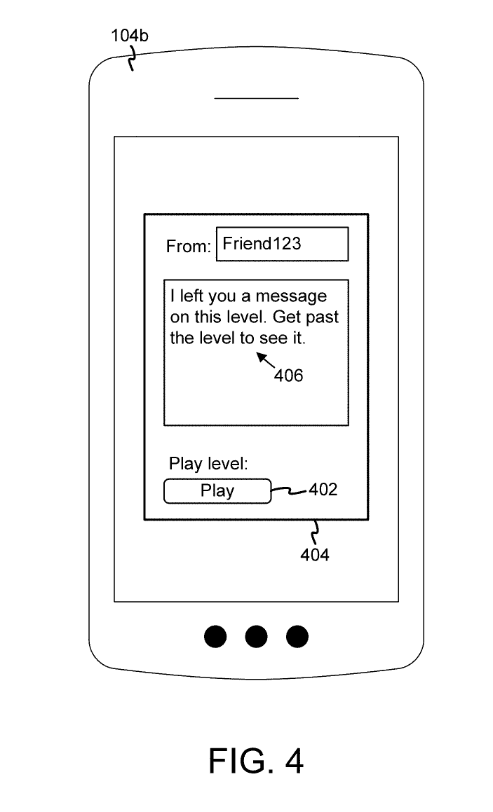

FIG. 4 depicts a further embodiment of a graphical display for video game communications. In one embodiment, the message module 202 may be configured to send a link 402 to a portion of a video game associated with the message 302 to the second user. The message module 202 may send the link 402 to the second user in a variety of ways. In certain embodiments, the message module 202 may send the link 402 to the second user (e.g., to a video game communications module 102 executing on a hardware device 104b associated with the second user, to an email address of the second user, in a text message associated with the second user, in a push notification to the second user, or the like). In one embodiment, the message module 202 may send a message 404 to the second user and the message may include the link 402. In one embodiment, the link 402 may be sent through a short message service (SMS) message, such as a text message. In one embodiment, the link 402 may be sent through an email. In one embodiment, the link 402 may be sent through a message sent over a third-party service such as Facebook, Twitter, or some other third-party service. In one embodiment, the link 402 may be sent through a message sent over an instant messaging service. In one embodiment, the message 404 may include text 406. In a further embodiment, the message 404 may include audio, an image, a video, or the like.

In one embodiment, the link 402 may be sent in a message 404 sent through the video game. For example, in one embodiment, a first user may specify a second user to receive the link 402 to the portion of the video game associated with the message 302 to the second user. The message module 202 may send the link 402 to the server 110, to a message module 202 associated with the second user, or the like. The second user may receive the link 402 directly on the hardware device 104b associated with the second user, may receive the link 402 in response to a module, such as the message module 202 or some other module of the video game communications module 102 interacting with the server 110, or the like. In one embodiment, the message module 202 may send the link 402 over the data network 108.

In one embodiment, the first user and the second user may use the same video game communications module 102, as mentioned above. The first user sending the link 402 to the second user may include the message module 202 storing the link 402 on the shared hardware device 104. The second user may receive the link 402 in response to using the video game communications module 102 on the shared hardware device 104, for example, by accessing the account of the second user for the video game, as mentioned above.

In one embodiment, the link 402 to the portion of the video game may comprise a deep link. In some embodiments, a deep link may include a uniform resource locator (URL), a hyperlink, or the like. In one embodiment, the deep link may identify a specific piece of content (e.g., the portion of the video game associated with a message). The content may include content on the Internet, content on a server or third-party platform, content in the video game, or the like. In embodiments where the link 402 comprises a deep link to a portion of the video game, the deep link may include an identifier for the video game and/or an associated server 110, and a unique identifier known to the trigger module 204 for the portion of the video game (e.g., a level identifier or the like).

As depicted in FIG. 2B, in one embodiment, the video game communications module 102 may include a deep link opening module 208. The deep link opening module 208 may be configured to interpret a deep link and to open the portion of the video game associated with the message 302 to the second user on the second user's device 104b based on the deep link.

For example, in one embodiment, the first user may associate the message 302 with the second level of the video game. The message module 202 may send a message comprising a deep link to the second level to the second user. The deep link may link to the second level of the video game (e.g., the level associated with the message 302 of the first user). The second user may receive the deep link to the second level of the video game. The deep link opening module 208 may open the second level of the video game on the second user's device 104b. The second user may play the second level of the video game. In one embodiment, the deep link opening module 208, the message module 202, or another module may download the message 302 associated with a portion of the video game. In a further embodiment, the module may download the message 302 from the server 110 or a third-party platform.

In one embodiment, the deep link opening module 208 may be configured to download the video game onto the second user's device 104b. For example, in one embodiment, the second user's device 104b may not include the video game. The second user may receive the link 402 to the portion of the video game associated with the message 302 from the first user. The deep link opening module 208 opening the link 402 from the first user may include downloading and/or installing the video game on the second user's device 104b. In response to the deep link opening module 208 downloading and/or installing the video game on the second user's device 104b, the deep link opening module 208 may open the portion of the video game associated with the message 302 of the first user on the second user's device 104b, as described above. In this manner, the first user may encourage the second user to play the video game and the video game's popularity and use may increase.

In one embodiment, the message module 202 may send a message from a first user comprising a link 402 to a portion of the video game to the second user and the portion of the video game may not be currently accessible to the second user. For example, in one embodiment, a video game may not allow a user to access a level where the user has not completed the previous level. The first user may send a link 402 to the third level of the video game to the second user, and the second user has completed the first level of the video game but has not completed the second level of the video game. In one embodiment, the deep link opening module 208 may open a portion of the video game previous to the portion of the video game associated with the message 302 of the first user (in the example, the second level of the video game). The display module 206 may present (e.g., display, play, or otherwise provide) a message to the user that the second user can access the message 302 of the first user in a further portion of the video game. In a further embodiment, the video game communications module 102 may allow a user to skip to a portion of a video game associated with a received message, even if the user has not yet progressed to the portion of the video game in the user's own play.

Returning to FIG. 2A, in one embodiment, the video game communications module 102 may include a trigger module 204. The trigger module 204 may be configured to determine that the second user has satisfied a trigger within the portion of the video game associated with the message 302 from the first user.

The trigger may include an event, occurrence, or the like in the video game. For example, in some embodiments, the trigger may include the second user reaching a certain point in a level of the video game, the second user selecting a portion of the video game, a portion of the video game becoming accessible to the second user, the second user acquiring a certain item in the video game, the second user completing the video game, or the like. In one embodiment, a portion of the video game may include multiple triggers. In a further embodiment, the trigger module 204 may determine that the user has satisfied one or more triggers. The second user, in certain embodiments, may satisfy each trigger separately (e.g., by satisfying different events, occurrence, or the like).

For example, a level or other portion of a video game may include a plurality of hidden portions of a message (e.g., one or more letters, words, and/or phrases from a larger message), which may be scrambled or out of order within the level or other portion of the video game, and which the second user may individually unlock and/or discover (e.g., a different trigger for each portion of the message). The display module 206, described below, in one embodiment, may provide a user interface to the second user allowing the second user to view each of the unlocked and/or discovered portions (e.g., at or toward an end of a level or other portion of a video game) and to unscramble the message (e.g., selecting and placing the portions of the message in one or more different orders until the message is unscrambled and/or decoded). The portions of a message, in certain embodiments, may be placed and/or hidden within a block or other object in a level or other portion of a video game, and the second user may open and/or break a block (e.g., by jumping into a block, stepping on a block, viewing a block, and/or performing another predefined action relative to a block) to unlock and/or discover the enclosed portion of the message, or the like. In one embodiment, the second user may satisfy multiple triggers simultaneously.

In one embodiment, a trigger may be built into the video game. In one embodiment, a trigger being built into the video game may include a trigger being present in the video game without customization of the first user. For example, in one embodiment, a built-in trigger may include the trigger of a user completing a level of the video game. In one embodiment, a trigger may be customized by a user. A trigger being customized by a user may include a user adding a trigger to the video game that was not present in the video game at the time the video game was released by the developer of the video game. For example, in one embodiment, a customized trigger may include the first user adding a trigger that the second user satisfies by reaching a point in the video game determined by the first user.

In one embodiment, the trigger may include the second user completing the portion of the video game. For example, in one embodiment, the trigger module 204 may determine that the second user has completed the level of the video game associated with the message 302 of the first user.

In one embodiment, the video game communications module 102 may include a display module 206. The display module 206 may be configured to display, play, present, and/or otherwise provide the message to the second user in response to the trigger module 204 determining that the second user has satisfied a trigger. In response to the trigger module 204 determining that the second user has satisfied the trigger, the display module 206 may present the message 302 from the first user associated with the portion of the video game to the second user.

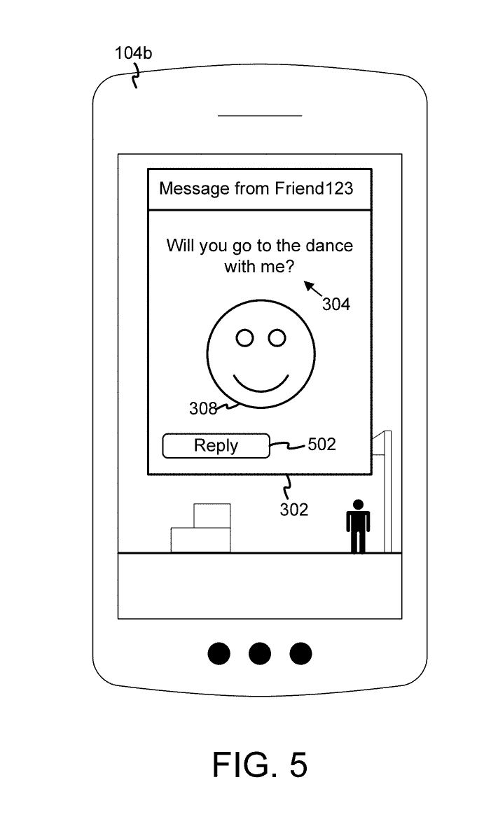

FIG. 5 depicts a further embodiment of a graphical display for video game communications. In one embodiment, the trigger may include the second user completing the level associated with the message 302 of the first user. As depicted in FIG. 5, in response to the second user completing the level associated with the message 302 of the first user, the trigger module may determine that the second user has satisfied the trigger. In response to the trigger module determining that the second user has completed the level and satisfied the trigger, the display module 206 may display the message 302 of the first user to the second user. In one embodiment, the message 302 may include the text 304, image 308, audio, and/or video that the first user inputted into the message 302. In certain embodiments, the message 302 may include a reply link 502, allowing the second user to use the message module 202 to send a reply message (e.g., associated with a different portion of the video game) to the first user, to another user, or the like.

As depicted in FIG. 2B, in one embodiment, the video game communications module 102 may include a portion unlock module 210. In one embodiment, the portion unlock module 210 may be configured to unlock a portion of the video game for the first user in response to the second user satisfying the trigger. In one embodiment, unlocking a portion of the video game for the first user may include allowing the first user to play or access a portion of the video game. In one embodiment, the trigger may include the second user completing a portion of the video game.

As discussed above, in one embodiment, the video game may include one or more portions. In one embodiment, one or more portions of the video game may be locked. In one embodiment, a locked portion may include a portion which the portion unlock module 210 does not allow a user to play or access, at least temporarily (e.g., until the user and/or another user unlocks the level or other portion, by completing a previous level or other portion, or satisfying a different trigger). In some embodiments, the portion unlock module 210, in response to a user satisfying a trigger, for example completing a portion of the video game, may unlock one or more locked portions. In one embodiment, a second user may satisfy a trigger and the portion unlock module 210 may unlock one or more portions of the video game for the first user.

For example, in one embodiment, a first level of the video game may be locked to the first user. The first user may unlock that level by satisfying a trigger. In this example, the trigger to unlock that level may include completing a second level. In this example, the terms “first level” and “second level” do not necessarily indicate an order of the one or more portions of the video game. The first user may not be able to complete the second level to satisfy the trigger. The first user may not be able to complete the second level for a variety of reasons, for example, because the second level is too difficult for the first user, or the like. The first user may send a message 404 to the second user indicating to the second user that the second user completing the second level will unlock the first level for the first user. The message 404 from the first user may include a link 402 to the second level. The second user may complete the second level and the trigger module may determine that the second user satisfied the trigger. In response to the second user satisfying the trigger, the portion unlock module 210 may unlock the first level of the video game for the first user.

In one embodiment, a portion of the video game may include the message 302 from the first user to the second user. The portion of the video game may include the message 302 from the first user in various forms. In one embodiment, one or more answers or solutions to the portion of the video game may include the message 302 from the first user. In one example, the portion of the video game may include a crossword puzzle, a word search puzzle, or any other type of word puzzle game and one or more answers to the puzzle may include the text of the message 302 from the first user. In one embodiment, one or more pieces of audio in the game may include the message 302 from the first user. In one embodiment, the portion of the video game may include an item in the video game and the item may include the message 302. In one embodiment, an in-game video of the video game may include the message 302 from the first user. In one embodiment, one or more lines of dialogue (e.g., text and/or audio) may include the message 302 of the first user to the second user.

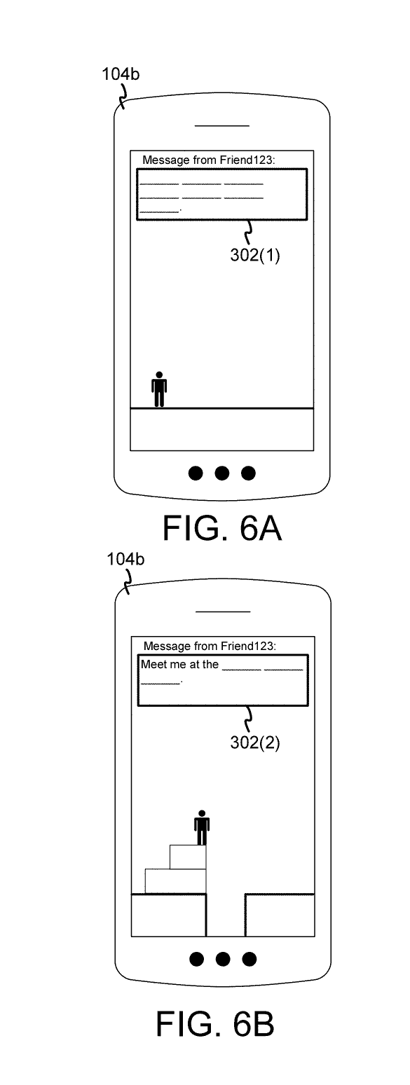

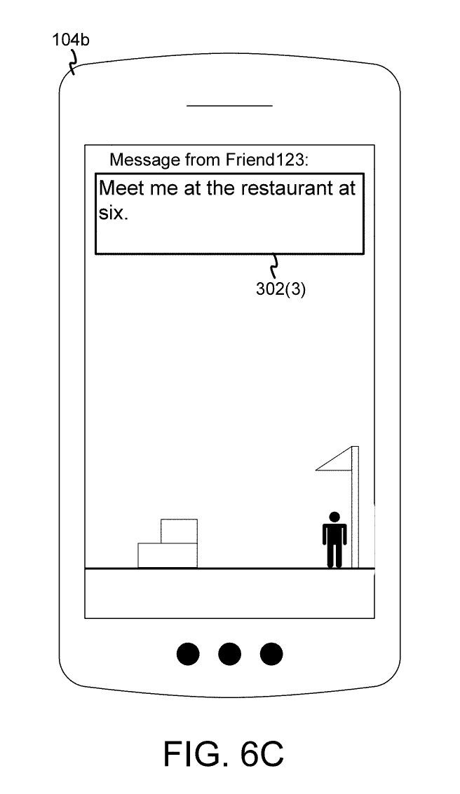

As depicted in FIGS. 6A-6C, in certain embodiments, the display module 206 may be configured to display a portion of the message from the first user to the second user in response to the trigger module determining that that the second user has satisfied the trigger. FIG. 6A depicts a further embodiment of a graphical display for video game communications. In one embodiment, the display module 206 may display an indication of the length, size, or the like of the message 302(1) from the first user. The display module 206 may display the indication 302(1) without initially displaying any portion of the message 302. For example, as depicted in FIG. 6A, the message 302(1) from the first user may include text and the words of the text may be temporarily replaced with blanks to indicate the number of words included in the message 302.

FIG. 6B depicts a further embodiment of a graphical display for video game communications. As depicted in FIG. 6B, in one embodiment, the display module 206 may display a portion of the message 302(2) from the first user to the second user in response to the trigger module determining that the second user has satisfied a trigger. In one embodiment, the first user may configure the message to display a certain portion of the message 302(2) in response to the second user satisfying a trigger. For example, in one embodiment, as depicted in FIG. 6B, the second user may reach a predetermined location in a level of the video game and satisfy a trigger. The trigger module may determine the second user has reached the predetermined location and, in response, display a portion of the message 302(2) from the first user. In one embodiment, the portion of the message 302(2) from the first user may be a portion of the message 302(2) that includes less than the entire message 302 from the first user.

In one embodiment, the first user may designate one or more triggers. In response to the second user satisfying each of the one or more triggers, the trigger module may determine that each trigger has been satisfied and, in response, the display module 206 may display a portion of the message to the second user. In one embodiment, the display module 206 may display a portion of the message 302(2) inversely proportional to the number of the one or more triggers. For example, in one embodiment, the first user may designate five triggers and the display module 206 may display one fifth of the message 302 in response to the user satisfying each trigger. In one embodiment, the first user may designate a portion of the message 302(2) to display in response to the second user satisfying each trigger of the one or more triggers. In one embodiment, the display module 206 may display the one or more portions of the message 302(2) in sequential order in response to the second user satisfying each trigger of the one or more triggers. In one embodiment, the display module 206 may display the one or more portions of the message 302(2) in a nonsequential order in response to the second user satisfying each trigger of the one or more triggers. In one embodiment, the first user may designate the order in which the display module 206 displays the one or more portions of the message 302(2) to the second user.

FIG. 6C depicts a further embodiment of a graphical display for video game communications. As depicted in FIG. 6C, in one embodiment, in response to the second user satisfying all of the one or more triggers, the trigger module may determine that the user has satisfied all of the one or more triggers and, in response, the display module 206 may display all of the portions of the one or more portions of the message 302(3) to the second user.

Returning to FIG. 2B, in one embodiment, the video game communications module 102 may include a portion customization module 212. In one embodiment, the portion customization module 212 may be configured to create and/or edit a customized portion for the video game (e.g., based on user input or the like). In one embodiment, the portion customization module 212 may be configured to embed a trigger into the customized portion. In one embodiment, the portion customization module 212 may be configured to receive a message 302 from the first user to be displayed to the second user in response to the trigger module determining that the second user has satisfied the embedded trigger.

In one embodiment, the portion customization module 212 may be configured to create a customized portion for the video game (e.g., a level editor or the like). In one embodiment, the customized portion may include a level, stage, screen, or the like of the video game. In one embodiment, the portion of the video game may include an item, character, or the like of the video game. In one embodiment, creating a customized portion for the video game may include creating a new customized portion for the video game. In one embodiment, creating a customized portion for the video game may include modifying an existing portion of the video game.

In one embodiment, the portion customization module 212 may be configured to embed a trigger into the customized portion. In one embodiment, embedding a trigger into the customized portion may include customizing the condition that will satisfy the trigger, designating the portion of the video game associated with the trigger, or the like.

In one embodiment, the portion customization module 212 may be configured to receive a message 302 from the first user to be displayed to the second user in response to the trigger module determining that the second user has satisfied the embedded trigger. For example, the portion customization module 212 may receive a message 302 from the first user, as described above in relation to the message module 202. In one embodiment, the portion customization module 212 may send the message 302 from the first user to the message module 202 and the message module 202 may receive the message 302 from the first user. In one embodiment, in response to the message module 202 receiving the message 302 from the first user, the message module 202 may prompt the first user to designate a second user to receive the message 302. In one embodiment, the message module 202 may send the designated second user a link to the customized portion of the video game associated with the message 302 from the first user.

As depicted in FIG. 2B, in one embodiment, the video game communications module 102 may include a message storage module 214. The message storage module 214 may be configured to store one or more messages. In one embodiment, the message storage module 214 may be configured to store one or more messages sent by a user. For example, in one embodiment, the message storage module 214 may be configured to store messages 302 sent by the first user. In one embodiment, the message storage module 214 may be configured to store one or more messages received by a user. For example, in one embodiment, the message storage module 214 may be configured to store messages 302 received by the second user, or the like. In one embodiment, the message storage module 214 may be configured to store one or more customized portions of the video game received by a user. For example, the message storage module 214 may be configured to store one or more customized portions of the video game received by the second user. In one embodiment, one or more stored message may include one or more message stored on the server 110 or a third-party service.

In one embodiment, the second user may access a stored message 302 from the first user at any time after the second user satisfies the trigger and receives the message 302 from the first user. In one embodiment, a message 302 may cease to be accessible to the second user in response to a certain amount of time passing from message module 202 receiving the message 302, the display module 206 displaying the message 302, or the like, as will be explained below. In one embodiment, the second user may store all messages received from other users. In one embodiment, the second user may sort the messages received from other users. For example, in one embodiment, the second user may group all messages associated with a certain level of the video game, group all messages associated with a certain user, list all messages in the order the second user received the messages, or the like. In one embodiment, the first user may store messages sent from the first user to other users.

In one embodiment, the display module 206 may be configured to determine an amount of timing having passed since the message module 202 received the message 302 from the first user and, in response to the amount of time having passed being less than a predetermined amount of time, display the message 302 to the second user. For example, in one embodiment, the predetermined amount of time may be 24 hours. The message module 202 may receive the message 302 from the first user. The second user may play the portion of the video game associated with the message 302 from the first user.

In one embodiment, the trigger module 204 may determine that the second user has satisfied the trigger associated with the message 302 from the first user, and in response, the display module 206 may determine whether 24 hours have passed since the message module 202 received the message 302 from the first user. In one embodiment, if 24 hours have not passed, the display module 206 may display the message 302 from the first user to the second user. In one embodiment, if 24 hours have passed, the display module 206 may not display the message 302 to the second user.

In one embodiment, in response to the predetermined amount of time passing, the trigger module 204 may no longer determine that the second user satisfies the trigger. In one embodiment, the trigger module 204 or other module may delete the trigger from the portion of the video game.

In one embodiment, if the display module 206 determines that the predetermined amount of time has passed since the message module 202 received the message from the first user, the display module 206 may display an alternate message to the second user. The alternate message may include a message to the second user indicating that the time to receive the message from the first user expired and/or that the message from the first user is no longer accessible.

In one embodiment, the first user may designate the predetermined amount of time. In one embodiment, the first user may designate the predetermined amount of time for each message 302 from the first user.

In one embodiment, the display module 206 may be configured to determine an amount of timing having passed since the display module 206 displayed the message 302 from the first user to the second user for the first time and, in response to the amount of time having passed being less than a predetermined amount of time, display the message 302 to the second user. In one embodiment, the second user may access a stored message 302 from the first user after the second user satisfies the trigger and receives the message 302 from the first user for the first time. For example, in one embodiment, the predetermined amount of time may be 24 hours. In one embodiment, the display module 206 may determine whether 24 hours have passed since the display module 206 displayed the message 302 from the first user to the second user for the first time. In one embodiment, if 24 hours have not passed, the display module 206 may display the message 302 from the first user to the second user. In one embodiment, if 24 hours have passed, the display module 206 may not display the message 302 to the second user. In one embodiment, in response to the predetermined amount of time passing, the message storage module 214 may delete the message 302.

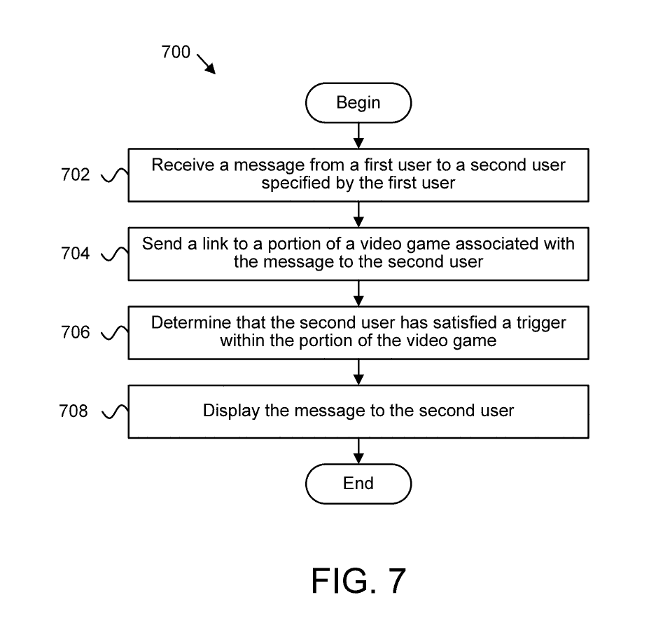

FIG. 7 depicts one embodiment of a method 700 for video game communications. The method 700 begins and the message module 202 may receive 702 a message from a first user to a second user specified by the first user. The message module 202 may send 704 a link to a portion of a video game associated with the message to the second user. The trigger module 204 may determine 706 that the second user has satisfied a trigger within the portion of the video game. The display module may display 708 the message to the second user in response to determining that the second user has satisfied the trigger, and the method 700 ends.

In one embodiment, the message from the first user may include text. In one embodiment, the message from the first user may include audio. In one embodiment, the message from the first user may include an image. In one embodiment, the message from the first user may include a video. In one embodiment, determining 706 that the second user has satisfied a trigger within the portion of the video game may include determining that the second user has completed the portion of the video game.

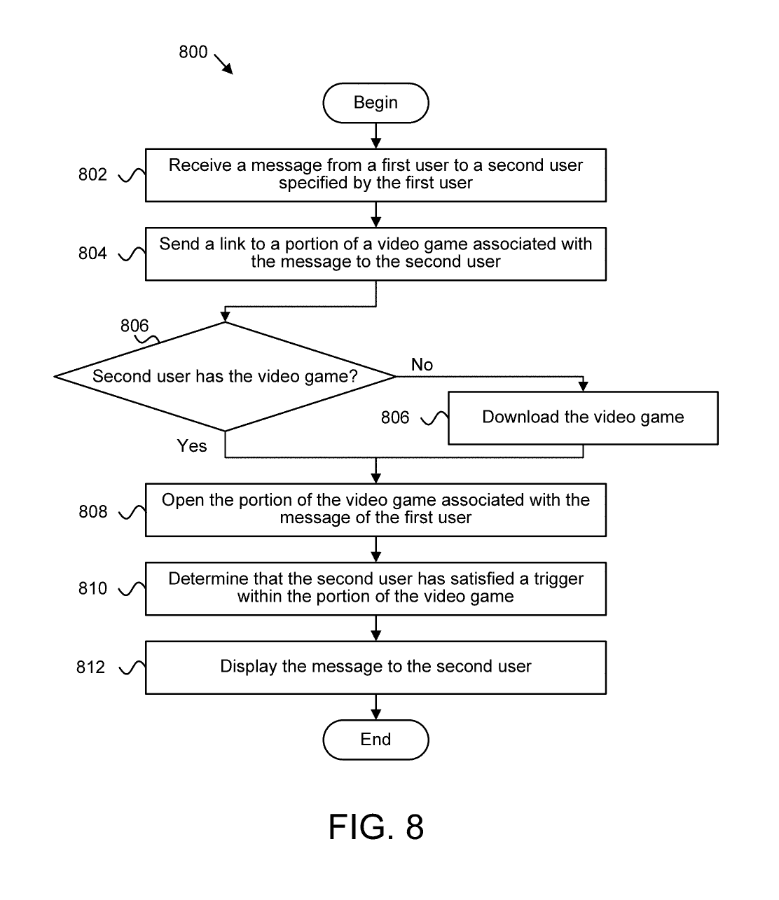

FIG. 8 depicts one embodiment of a method for video game communications 800. The method 800 begins and the message module 202 may receive 802 a message from a first user to a second user specified by the first user. The message module 202 may send 804 a link to a portion of a video game associated with the message to the second user. The deep link opening module 208 may determine 806 whether the second user has the video game installed on the second user's device 104b. If the second user does not have the video game downloaded and/or installed on the second user's device 104b, the deep link opening module 208 may download and/or install the video game onto the second user's device 104b. The deep link module 208 may open 808 the portion of the video game associated with the message from the first user. The trigger module 204 may determine 810 that the second user has satisfied a trigger within the portion of the video game. The display module may display 812 the message to the second user in response to determining that the second user has satisfied the trigger, and the method 800 ends.

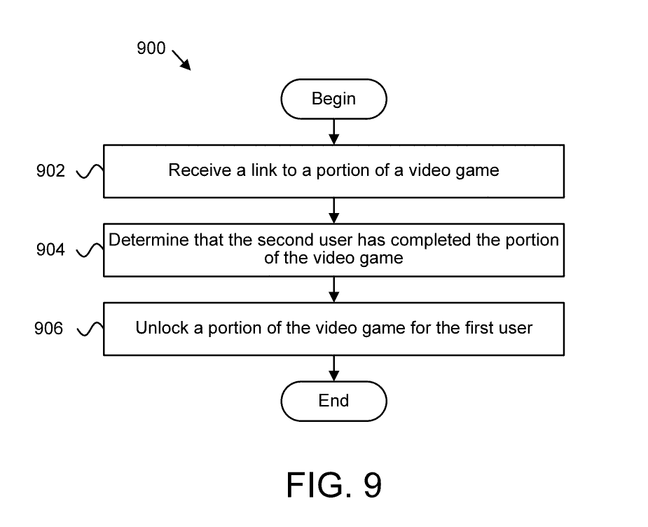

FIG. 9 depicts one embodiment of a method for video game communications 900. The method 900 begins and the message module 202 may receive 902 a link to a portion of a video game. The trigger module 204 may determine that the second user has completed the portion of the video game. The portion unlock module 210 may unlock a portion of the video game for the first user, and the method 900 ends

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a message module configured to receive a message from a first user to a second user specified by the first user and to send a link to a portion of a video game associated with the message to the second user;
a trigger module configured to determine that the second user has satisfied a trigger within the portion of the video game; and
a display module configured to present the message to the second user in response to the trigger module determining that the second user has satisfied the trigger.

2. The apparatus of claim 1, wherein the message from the first user comprises one or more of:
text;
audio;
an image; and
a video.

3. The apparatus of claim 1, wherein the trigger comprises the second user completing the portion of the video game.

4. The apparatus of claim 1, wherein the link to the portion of the video game comprises a deep link to the portion of the video game within the video game.

5. The apparatus of claim 4, further comprising a deep link opening module configured to open the portion of the video game associated with the message to the second user on a device of the second user based on the deep link.

6. The apparatus claim 5, wherein the deep link opening module is further configured to download at least the portion of the video game onto the device of the second user.

7. The apparatus of claim 1, further comprising a portion unlock module configured to unlock the portion of the video game for the first user in response to the second user satisfying the trigger, wherein the trigger comprises the second user completing the portion of the video game.

8. The apparatus of claim 1, wherein the display module is configured to present the message from the first user to the second user within the portion of the video game.

9. The apparatus of claim 1, wherein the display module is configured to present a first portion of the message from the first user to the second user in response to the trigger module determining that the second user has satisfied a first element of the trigger and to present a second portion of the message from the first user to the second user in response to the trigger module determining that the second user has satisfied a second element of the trigger.

10. The apparatus of claim 9, wherein the display module is configured to provide an interface to the second user allowing the second user to unscramble the first portion, the second portion, and one or more additional portions of the message to form the message in response to the second user satisfying each of a plurality of elements of the trigger.

11. The apparatus of claim 1, further comprising a portion customization module configured to:
create a customized portion for the video game;
embed a trigger into the customized portion; and
receive a message from the first user to be provided to the second user in response to the trigger module determining that the second user has satisfied the embedded trigger.

12. The apparatus of claim 1, further comprising a message storage module configured to store one or more of:
one or more messages sent by the first user;
one or more messages received by the second user; and
one or more customized portions of the video game received by the second user.

13. The apparatus of claim 1, wherein the display module is configured to determine an amount of time that has passed since the message module received the message from the first user and, in response to the amount of time being less than a predetermined amount of time, to present the message to the second user and, in response to the amount of time being greater than a predetermined amount of time, to expire the message without presenting the message to the second user.

14. A method comprising:
receiving, at a hardware device of a second user, a link to a portion of a video game associated with a message from a first user to the second user, the video game executing on the hardware device of the second user;
determining that the second user has satisfied a trigger within the portion of the video game on the hardware device; and
displaying the message to the second user on an electronic display of the hardware device in response to determining that the second user has satisfied the trigger.

15. The method of claim 14, wherein the message from the first user comprises one or more of:
text;
audio;
an image; and
a video.

16. The method of claim 14, wherein determining that the second user has satisfied the trigger within the portion of the video game comprises determining that the second user completed the portion of the video game.

17. The method of claim 14, further comprising opening the portion of the video game associated with the message to the second user on a device of the second user.

18. The method of claim 14, further comprising unlocking the portion of the video game for the first user in response to the second user satisfying the trigger, wherein the trigger comprises the second user completing the portion of the video game.

19. A computer program product comprising a computer readable storage medium storing computer executable program code to perform operations, the operations comprising:
receiving, at a hardware device of a second user, a link to a portion of a video game associated with a message from a first user to the second user, the video game executing on the hardware device of the second user;
determining that the second user has satisfied a trigger within the portion of the video game on the hardware device; and
presenting the message to the second user on the hardware device in response to determining that the second user has satisfied the trigger.

20. The computer program product of claim 19, wherein determining that the second user has satisfied the trigger within the portion of the video game comprises determining that the second user completed the portion of the video game.
